(19) United States
(12) Patent Application Publication
(10) Pub. No.: US 2020/0094089 A1
(43) Pub. Date: Mar. 26, 2020

(54) AIRCRAFT FIRE SUPPRESSION SYSTEMS

(71) Applicant: Kidde Technologies, Inc., Wilson, NC (US)

(72) Inventors: Harlan Hagge, Knightdale, NC (US); Terry Simpson, Wake Forest, NC (US)

(21) Appl. No.: 16/139,639

(22) Filed: Sep. 24, 2018

(51) Int. Cl. A62C 3/08; A62C 35/02; A62C 35/64; A62C 5/00

(52) U.S. Cl. CPC A62C 3/08; A62C 5/00; A62C 35/64; A62C 35/023

(57) ABSTRACT

Fire suppression systems for aircraft are described. The fire suppression systems include a first fire suppression material source containing a first constituent, a second fire suppression material source containing a second constituent different from the first constituent, and a fluid supply line connecting the first fire suppression material source and the second fire suppression material source to at least one dispenser configured to dispense the first constituent in the form of a first agent in a high rate discharge operation to extinguish a detected fire, and to dispense the second constituent in the form of a second agent in a low rate discharge operation after the high rate discharge operation.

### BACKGROUND

The subject matter disclosed herein generally relates to aircraft and, more particularly, to fire suppression systems for aircraft.

Fire suppression systems are often used in aircraft, buildings, or other structures having contained areas. Fire suppression systems typically utilize halogenated fire suppressants, such as halons. However, halogens are believed to play a role in ozone depletion of the atmosphere. Accordingly, there has been a trend to remove Halon a source for fire suppression for enclosed spaces (e.g., on aircraft).

Most buildings and other structures have replaced Halon-based fire suppression systems; however aviation applications are more challenging because space and weight limitations are of greater concern than non-aviation applications. Also the cost of design and recertification is a very significant impediment to rapid adoption of new technologies in aviation.

As noted, current aircraft with cargo compartments have fire-suppression systems as a safety feature in the event of a fire in the cargo compartment. In the event of a fire in the cargo compartment, fire suppression is achieved by an initial rapid discharge (“high rate discharge” or “HRD”) of Halon into the cargo compartment to establish a minimum Halon concentration. The HRD provides effective and fast initial flame knockdown. Sustained fire suppression (“low rate discharge” or “LRD”) is provided to work against deep-seated fire and conflagrations, wherein a low rate of discharge of the suppressant is employed to maintain a concentration of suppressant.

The typical fire-suppression systems on large commercial aircraft achieve the initial HRD by very quickly releasing the entire contents of one or more high-rate discharge (HRD) containers of Halon into the area having the fire (e.g., cargo compartment). After the HRD bottle(s) are discharged, the Halon concentration peaks and then slowly decreases. The Halon concentration in the cargo compartment is then maintained by providing a substantially continuous, regulated flow of Halon from a plurality of “metered” containers over an elongated period of time (i.e., the LRD).

### SUMMARY

According to some embodiments, fire suppression systems for aircraft are provided. The fire suppression systems include a first fire suppression material source containing a first constituent, a second fire suppression material source containing a second constituent different from the first constituent, and a fluid supply line connecting the first fire suppression material source and the second fire suppression material source to at least one dispenser configured to dispense the first constituent in the form of a first agent in a high rate discharge operation to extinguish a detected fire, and to dispense the second constituent in the form of a second agent in a low rate discharge operation after the high rate discharge operation.

In addition to one or more of the features described above, or as an alternative, further embodiments of the fire suppression systems may include that the first agent of the high rate discharge comprises a combination of the first constituent and at least one additional material.

In addition to one or more of the features described above, or as an alternative, further embodiments of the fire suppression systems may include that the first agent of the high rate discharge comprises a combination of the first constituent and the second constituent, and the second agent of the low rate discharge comprises only the second constituent.

In addition to one or more of the features described above, or as an alternative, further embodiments of the fire suppression systems may include that the first agent comprises at least the first constituent and a third constituent, and wherein the first constituent and the second constituent are the same material.

In addition to one or more of the features described above, or as an alternative, further embodiments of the fire suppression systems may include that the first agent is formed by mixing the first constituent and the second constituent within at least one of the fluid supply line and the at least one dispenser.

In addition to one or more of the features described above, or as an alternative, further embodiments of the fire suppression systems may include a fire detection system having at least one fire detector arranged to detect a fire on the aircraft.

In addition to one or more of the features described above, or as an alternative, further embodiments of the fire suppression systems may include that the at least one dispenser is located in one of a cargo compartment, an engine, an engine nacelle, and an auxiliary power unit of the aircraft.

In addition to one or more of the features described above, or as an alternative, further embodiments of the fire suppression systems may include that the first constituent is Pentafluoroethane (HFC-125) and the second constituent is Trifluoroiodomethane (CF3I).

In addition to one or more of the features described above, or as an alternative, further embodiments of the fire suppression systems may include a manifold arranged along the fluid supply line, wherein the manifold is configured to at least one of (i) control flow of fluid from each of the first fire suppression material sources and (ii) mix the first constituent and the second constituent.

In addition to one or more of the features described above, or as an alternative, further embodiments of the fire suppression systems may include that the first agent contains solid particulate.

In addition to one or more of the features described above, or as an alternative, further embodiments of the fire suppression systems may include that the particulate is at least one of sodium bicarbonate and vermiculite.

In addition to one or more of the features described above, or as an alternative, further embodiments of the fire suppression systems may include a meter located along the fluid supply line between the second fire suppression material source and the at least one dispenser, wherein the meter is configured to control a flow rate of the second constituent from the second fire suppression material source during the low rate discharge operation.

In addition to one or more of the features described above, or as an alternative, further embodiments of the fire suppression systems may include that the first agent comprises a mixture of hydrofluorocarbons, such as HFC-125, HFC-23, HFC-227ea, HFC-236fa, heptafluoroisopropyl pentafluoroethyl ketone, and/or Trifluoroiodomethane (CF3I), in an azeotrope

According to some embodiments, methods for fire suppression on aircraft are provided. The methods include dispensing a first agent in a high rate discharge to extinguish a detected fire and after dispensing the first agent, dispensing a second agent in a low rate discharge at or near where the fire was detected. The first agent is different from the second agent.

In addition to one or more of the features described above, or as an alternative, further embodiments of the methods may include that the first agent and the second agent have at least one common constituent.

In addition to one or more of the features described above, or as an alternative, further embodiments of the methods may include mixing a first constituent from a first fire suppression material source with a second constituent from a second fire suppression material source to form the first agent.

In addition to one or more of the features described above, or as an alternative, further embodiments of the methods may include that the second agent comprises only the second constituent, and, wherein the first constituent is Pentafluoroethane (HFC-125) and the second constituent is Trifluoroiodomethane (CF3I)

In addition to one or more of the features described above, or as an alternative, further embodiments of the methods may include that at least one of the high rate discharge and the low rate discharge are performed automatically upon detection of the fire.

In addition to one or more of the features described above, or as an alternative, further embodiments of the methods may include that the first agent comprises a mixture of hydrofluorocarbons, such as HFC-125, HFC-23, HFC-227ea, HFC-236fa, heptafluoroisopropyl pentafluoroethyl ketone, and/or Trifluoroiodomethane (CF3I), in an azeotrope.

In addition to one or more of the features described above, or as an alternative, further embodiments of the methods may include that the first agent contains solid particulate.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic illustration of an aircraft that may employ embodiments of the present disclosure;

FIG. 2 is a schematic illustration of a fire suppression system in accordance with an embodiment of the present disclosure;

FIG. 3 is a schematic illustration of a fire suppression system in accordance with an embodiment of the present disclosure; and

FIG. 4 is a flow process for operation of a fire suppression system in accordance with an embodiment of the present disclosure.

### DETAILED DESCRIPTION

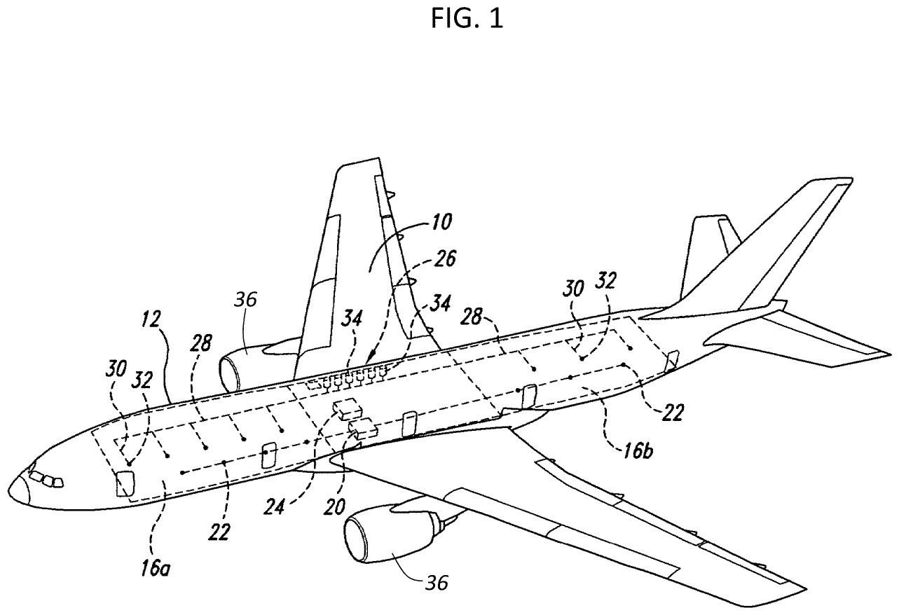

FIG. 1 is a schematic illustration of an aircraft 10 with a fuselage 12 that contains one or more cargo compartments. For example, as shown in FIG. 1, the aircraft 10 includes a forward cargo compartment 16a and an aft cargo compartment 16b. The cargo compartments 16a, 16b are sized to receive cargo containers or pallets (not shown) that can include a vast assortment of different items, containers, and materials.

The aircraft also includes a fire detection system 20 (shown schematically) to provide fire detection in the cargo compartments 16a, 16b. The fire detection system 20 includes a plurality of detectors 22 configured to provide a signal to an aircraft control system 24 (shown schematically) upon detecting an actual or potential fire condition in one or both of the forward car compartment 16a and the aft cargo compartment 16b. The control system 24 is configured to provide a warning to the operator of the aircraft 10 in the event at least one of the detectors 22 is activated within any of the cargo compartments 16a, 16b.

The aircraft 10 also includes a fire-suppression system 26 that is operably connected to the fire detection system 20 and the control system 24. The fire-suppression system 26 is coupled to the control system 24 and is activated manually or automatically by the control system 24 if a fire condition is detected. The fire-suppression system 26 is configured to disperse a fire suppressant, such as Halon, into the cargo compartment(s) 16a, 16b having a detected fire. The fire suppressant is initially dispersed into the respective compartment(s) 16a, 16b at elevated levels to extinguish any flame that may be present, i.e., a high rate discharge (“HRD”). The fire suppressant is also dispersed into the respective compartment(s) 16a, 16b over an extended period of time after the initial HRD to maintain a selected fire suppressant concentration level that prevents any subsequent flare-ups, i.e., a low rate discharge (“LRD”). For example, an HRD discharge time may be a rate of about 10-160 lbs of material over a period of about 60 seconds (i.e., 10-160 lbs/minute), dependent on bay volume to be protected. An LRD discharge time, for example, may last for about 60-330 minutes, depending on extended operations of the aircraft, and rates may depend on ventilation rates of a bay, e.g., between 0.2 and about 1 lb/min. These are merely examples of rates of discharge for HRD and LRD, as will be appreciated by those of skill in the art.

As illustratively shown, the fire-suppression system 26 includes a main line 28 that carries a flow of fire suppressant to the cargo compartments 16a, 16b. A plurality of distributing lines 30 branch off from the main line 28 and may be spaced apart from each other within the cargo compartments 16a, 16b. Each of the distributing lines 30 terminates at a discharge nozzle 32 configured to disperse the fire suppressant into the respective forward cargo compartment 16a or the aft cargo compartment 16b. The distributing lines 30 and the discharge nozzles 32 are positioned so that, when the fire-suppression system 26 is activated, the fire suppressant will be dispersed substantially uniformly to rapidly achieve a uniform concentration of fire suppressant throughout the target compartment 16. The flow of fire suppressant through the main line 28 can be directed to one or more of the discharge nozzles 32 through the distributing lines 30, which may include various valve arrangements to provide targeted fire suppression. The activation of the fire-suppression system 26 may be triggered in response to a command from a pilot of the aircraft 10 or from an automatic command from the control system 24.

Additionally, in some configurations, fire suppression systems may be configured to apply fire suppression for engines of the aircraft 10. As shown in FIG. 1, the aircraft 10 includes engines 36, as will be appreciated by those of skill in the art. In this illustration, the engines 36 are wing-mounted, although other configurations are possible without departing from the scope of the present disclosure. Each engine may be configured with a nacelle that houses a gas turbine. Additionally, the aircraft 10 can include an auxiliary power unit (APU), as will be appreciated by those of skill in the art. A single fire suppression system or multiple fire suppression systems may be arranged within or on an aircraft to provide fire suppression to the cargo compartment(s), engine(s), engine nacelle(s), APU(s), or other locations and/or areas on an aircraft.

Embodiments of the present disclosure are directed at replacing typical Halon systems with improved fire-suppression systems. In accordance with some embodiments, an extinguishing agent system is provided that conforms to the same overall architecture that has served the aviation industry well over the past decades in terms of reliability (dispatch), operational safety, and maintenance personal safety. It is noted that other systems existing systems have attempted to remove reliance on Halon, with such systems relying upon water mist and/or on-board inert gas systems that are fairly complex and thus impact cost, dispatch reliability, weight, and/or aircraft integration. Other non-Halon systems may employ carbon dioxide (CO₂) as the inerting agent plus Hydrofluorocarbons (HFC) or bromotrifluoropropene (BTP), however such systems have a negative impact on system weight and/or may be considered too toxic for use, which is a concern for aerospace and aircraft applications. Moreover, CO₂ may be less efficient and/or effective than other chemical compositions.

In accordance with embodiments of the present disclosure, fire-suppression systems described herein utilize an HRD/LRD architecture, as described above, but employ environmentally friendly (low global warming potential “GWP”/ozone depletion potential “ODP”) agents, with two different agents employed for the HRD and the LRD. For example, in some embodiments, an environmentally friendly agent, such as Trifluoroiodomethane (CF₃I), may be mixed to provide an acceptable toxicological, environmental, and fire suppression efficiency property combination for aviation fire protection applications.

In one non-limiting example, a blend of CF₃I and Pentafluoroethane (HFC-125) in a cargo bay, engine (or engine nacelle), and/or APU application can be provided to extinguish a fire in such area of the aircraft. Such blend may be toxicologically acceptable for short term exposures (e.g., HRD). In some embodiments, an undiluted CF₃I agent or mixture of CF₃I and HFC-125 can be employed to provide weight efficiency to the fire suppression system. As noted above, other systems typically utilize carbon dioxide (CO₂) as the inerting agent plus HFCs or BTP, however CO₂ has a negative impact on system weight, in part because CO₂ is less efficient as a fire suppressant than CF3I, and thus additional material may be required. In addition, the boiling points of CF₃I and HFC-125 are more closely matched so agent stratification is less of an issue after discharge due to agent density differences. This is particularly true for embodiments that employ an azeotrope.

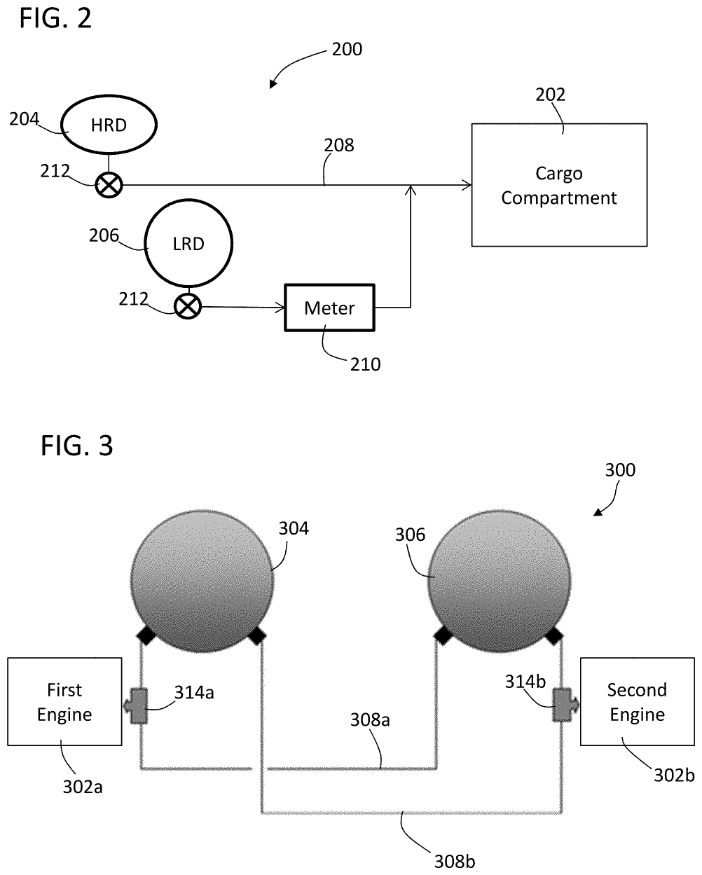

Turning now to FIG. 2, a schematic illustration of a fire suppression system 200 in accordance with an embodiment of the present disclosure is shown. The fire suppression system 200 may be installed on an aircraft and may be arranged to supply fire suppression to one or more locations or areas on the aircraft (e.g., cargo compartment(s), engine(s), engine nacelle(s), APU(s), etc.). The illustration of FIG. 2 is schematic for a system that supplies fire suppression to a cargo compartment 202. Those of skill in the art will appreciate that the cargo compartment 202 may be replaced (or additionally include) engines, engine nacelles(s), APUs, or other locations on an aircraft, without departing from the scope of the present disclosure.

The fire suppression system 200 includes a first fire suppression material source 204 and a second fire suppression material source 206. The first and second fire suppression material sources 204, 206 are fluidly connected to the cargo compartment 202 through a fluid supply line 208. The fluid supply line 208 may include one or more nozzles or dispensers located on an end thereof that are arranged to dispense or disperse one or both of a first agent and a second agent from the respective first and second fire suppression material sources 204, 206. As labeled, the first fire suppression material source 204 is arranged to provide a first agent in the form of an initial rapid discharge (i.e., high rate discharge or HRD). The second fire suppression material source 206 is arranged to provide a second agent in the form of a sustained fire suppression (i.e., low rate discharge or LRD). To provide the sustained fire suppression, a meter 210 may be arranged relative to the second fire suppression material source 206 to meter the flow of the second agent from the second fire suppression material source 206. Further, one or more valves 212 can be arranged along the fluid supply line 208 to control from which agent source a fluid is dispensed into the cargo compartment 202.

The first agent within the first fire suppression material source 204 may be a different composition than the second agent within the second fire suppression material source 206. The two compositions may be selected for the specific application (e.g., HRD versus LRD). In some embodiments, the first agent may be formed from one or more constituents and the second agent may be formed from one or more constituents. The constituents of the first and second agents may be selected with at least one constituent being different between the first agent and the second agent.

For example, different fire extinguishing materials can exhibit different densities, yet when combined there can be synergistic effects so that the fire protection effectiveness is enhanced by the blend of different materials/compositions/chemicals/compounds/etc. The differing densities, however, can lead to stratification and/or settling out of one of the blend constituents so that separation will occur. The settling and/or separation may be problematic in aircraft cargo bays where protection is required for up to several hours (LRD) after an initial knock-down of a fire (HRD).

In one non-limiting embodiment, a blend of fire extinguishing agents (or constituents) is employed for the initial high rate discharge (HRD) portion of the fire suppression (first agent), and a single fire extinguishing agent is employed for the low rate discharge (LRD) sustained fire protection duration (second agent). The benefit of synergistic effects with the blend of agents is important during the initial knock-down of the fire event. The LRD duration, however, may require a sustained inerting concentration and does not need to directly attack the fire threat. During the brief HRD portion of the suppression, multiple agents in the blend can act together to attack the fire challenge before appreciable settling or stratification of the agents occurs. Subsequently, one of the fire extinguishing agents (e.g., constituent of the first agent), or a different material/chemical, can be employed in the LRD for longer duration fire suppression control.

As such, the HRD of the present disclosure may be composed of at least a first constituent and a second constituent and the LRD may be composed of at least a third constituent. In some embodiments, the first and third constituents may be the same material/chemical/composition and in other embodiments the third constituent may be different from both the first and second constituents.

Turning now to FIG. 3, a schematic illustration of a fire suppression system 300 in accordance with an embodiment of the present disclosure is shown. The fire suppression system 300 may be installed on an aircraft and may be arranged to supply fire suppression to one or more locations or areas on the aircraft (e.g., cargo compartment(s), engine(s), APU(s), etc.). The illustration of FIG. 3 is schematic for a system that supplies fire suppression to a first engine 302a and a second engine 302b. Those of skill in the art will appreciate that the engines 302a, 302b may be replaced (or additionally include) cargo compartments, APUs, or other locations on an aircraft, without departing from the scope of the present disclosure.

The fire suppression system 300 includes a first fire suppression material source 304 and a second fire suppression material source 306. The first and second fire suppression material sources 304, 306 are fluidly connected to the first engine 302a through a first fluid supply line 308a. The first and second fire suppression material sources 304, 306 are fluidly connected to the second engine 302b through a second fluid supply line 308b. As shown, a first manifold 314a (e.g., T-shaped manifold) is arranged on the first fluid supply line 308a and is configured to blend and/or mix a first agent from the first fire suppression material source 304 with a second agent from the second fire suppression material source 306 prior to dispensing into or at the first engine 302a. Further, a second manifold 314b is arranged on the second fluid supply line 308b and is configured to blend and/or mix a first agent from the first fire suppression material source 304 with a second agent from the second fire suppression material source 306 prior to dispensing into or at the second engine 302b. The fluid supply lines 308a, 308b may include one or more nozzles or dispensers located on an end thereof that are arranged to dispense or disperse one or both of the first agent and the second agent from the respective first and second fire suppression material sources 304, 306.

In this embodiment, the first and second agents may be contained separately, with mixing of the two agents achieved within or along the fluid supply lines 308a, 308b (e.g., at the manifolds 314a, 314b). As labeled, the first fire suppression material source 304 is arranged to provide a first agent and the second fire suppression material source 306 is arranged to provide a second agent. An HRD or LRD can be controlled at the manifolds 314a, 314b and/or at nozzles or other dispensing mechanisms at or in the respective engines 302a, 302b. In some embodiments, an HRD may be provided by supplying both the first agent and the second agent in a mixture into or at the engines 302a, 302. Further, an LRD may be provided by supplying a continuous and/or metered supply of one of the two agents (i.e., first or second agent).

As provided herein, and as noted above, the first and second agents may be composed of multiple different constituents. As such, a specific fire suppression procedure may be achieved with a highly efficient HRD and a highly efficient LRD. Further, the selection of the constituents of each agent (e.g., chemical, compound, mixture, etc.) may be selected for efficacy for fire suppression and for other considerations (e.g., weight, environmental impact, toxicity, etc.).

For example, in one non-limiting embodiment, the blend (either the first agent or a combination of a first and second agent (or more than two)) could be tailored to reduce the toxicological impact of using CF₃I and so allow short term exposure with no negative effects if maintenance personnel are in the bay to be protected. Adding HFC-125 or another flourocarbon could provide a desired toxicological benefit. In one non-limiting example, a blend in accordance with the present disclosure can consist of a mixture of hydrofluorocarbons, such as HFC-125, HFC-23, HFC-227ea, HFC-236fa, heptafluoroisopropyl pentafluoroethyl ketone, and/or CF₃I, in an azeotrope. The blend can also contain solid particulate fire suppression constituents such as sodium bicarbonate or vermiculite. A substance that attracts water can be included to act as a moisture absorber or attractor to mitigate undesirable chemical reactions from the presence of water in the blend.

In some embodiments, if high concentrations or non-diluted CF₃I is used an odorant can be included so that in the case of the use of agents with a toxicological concern there can be a noticeable and detectable signal in the event of a discharge of agent in the presence of personnel. In this example, “high concentration” refers to concentrations above the LOAEL 0.4% and NOAEL 0.2% for CF3I. Additional safety precautions can consist of system interlocks so that discharge of one or more of the agents of the fire suppression systems is prevented when the aircraft is on the ground by use of a weight-on-wheels switch to provide an open circuit that prevents electrical actuation of agent discharge, as will be appreciated by those of skill in the art. Audible notification can be provided to personnel through the use of an alarm in detectors that sense concentrations of one or more agents (or constituents thereof). In some embodiments, secondary gas sensors and/or an odorant in the agent(s) may be employed in areas in which personnel may be located in order to advise of agent discharge.

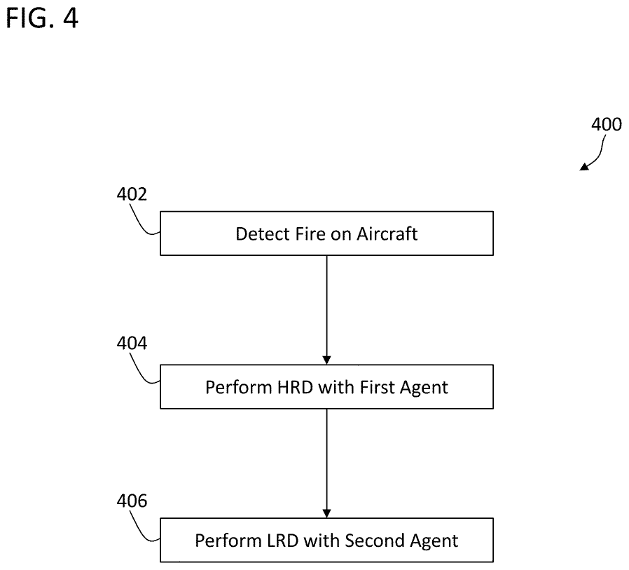

Turning now to FIG. 4, a flow process 400 for operation a fire suppression system in accordance with an embodiment of the present disclosure is shown. The first suppression system may be similar to that described above, wherein at least a first agent is employed for an HRD and a second agent is employed for an LRD, wherein the constituents of the first agent and the second agents are different.

At block 402, a fire may be detected aboard an aircraft, with such detection made by one or more sensors. The location of the fire may be within one or more cargo compartments, on or in one or more engines (or engine housings), on or in an auxiliary power unit (APU) of the aircraft, or other location, and/or combinations thereof.

At block 404, upon detection of a fire on the aircraft, a high rate discharge (HRD) is performed employing a first agent. In some embodiments, the first agent may be sourced from a single, dedicated container or source. In other embodiments, the first agent may be a combination of constituents sourced from different sources and mixed at the time of dispensing (e.g., within a fluid supply line and/or at a nozzle).

At block 40, after the HRD of block 404, a low rate discharge (LRD) is performed employing a second agent. The second agent is different from the first agent. In some embodiments, one or more constituents of the second agent may be the same as constituents of the first agent, but at least one constituent of the second agent is different from the constituents of the first agent.

Advantageously, two-step fire suppression systems are provided herein. The two-step fire suppression systems of the present disclosure employ a first agent for a high rate discharge (HRD) and a second (different) agent is employed for a low rate discharge (LRD). Advantageously, the constituents of the first and second agents may be selected for not only efficacy in fire suppression, but also based on other considerations, including, but not limited to environmental concerns, weight, toxicity, etc.

The use of the terms “a,” “an,” “the,” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other. It should be appreciated that relative positional terms such as “forward,” “aft,” “upper,” “lower,” “above,” “below,” and the like are with reference to normal operational attitude and should not be considered otherwise limiting.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

Accordingly, the present disclosure is not to be seen as limited by the foregoing description, but is only limited by the scope of the appended claims.

What is claimed is:

1. A fire suppression system for an aircraft, the fire suppression system comprising:
a first fire suppression material source containing a first constituent;
a second fire suppression material source containing a second constituent different from the first constituent; and
a fluid supply line connecting the first fire suppression material source and the second fire suppression material source to at least one dispenser configured to dispense the first constituent in the form of a first agent in a high rate discharge operation to extinguish a detected fire, and to dispense the second constituent in the form of a second agent in a low rate discharge operation after the high rate discharge operation.

2. The fire suppression system of claim 1, wherein the first agent of the high rate discharge comprises a combination of the first constituent and at least one additional material.

3. The fire suppression system of claim 1, wherein the first agent of the high rate discharge comprises a combination of the first constituent and the second constituent, and the second agent of the low rate discharge comprises only the second constituent.

4. The fire suppression system of claim 1, wherein the first agent comprises at least the first constituent and a third constituent, and wherein the first constituent and the second constituent are the same material.

5. The fire suppression system of claim 1, wherein the first agent is formed by mixing the first constituent and the second constituent within at least one of the fluid supply line and the at least one dispenser.

6. The fire suppression system of claim 1, further comprising a fire detection system having at least one fire detector arranged to detect a fire on the aircraft.

7. The fire suppression system of claim 1, wherein the at least one dispenser is located in one of a cargo compartment, an engine, an engine nacelle, and an auxiliary power unit of the aircraft.

8. The fire suppression system of claim 1, wherein the first constituent is Pentafluoroethane (HFC-125) and the second constituent is Trifluoroiodomethane (CF₃I).

9. The fire suppression system of claim 1, further comprising a manifold arranged along the fluid supply line, wherein the manifold is configured to at least one of (i) control flow of fluid from each of the first fire suppression material sources and (ii) mix the first constituent and the second constituent.

10. The fire suppression system of claim 1, wherein the first agent contains solid particulate.

11. The fire suppression system of claim 10, wherein the particulate is at least one of sodium bicarbonate and vermiculite.

12. The fire suppression system of claim 1, further comprising a meter located along the fluid supply line between the second fire suppression material source and the at least one dispenser, wherein the meter is configured to control a flow rate of the second constituent from the second fire suppression material source during the low rate discharge operation.

13. The fire suppression system of claim 1, wherein the first agent comprises a mixture of hydrofluorocarbons, such as HFC-125, HFC-23, HFC-227ea, HFC-236fa, heptafluoroisopropyl pentafluoroethyl ketone, and/or Trifluoroiodomethane (CF₃I), in an azeotrope

14. A method for fire suppression on an aircraft, the method comprising:
dispensing a first agent in a high rate discharge to extinguish a detected fire; and
after dispensing the first agent, dispensing a second agent in a low rate discharge at or near where the fire was detected,
wherein the first agent is different from the second agent.

15. The method of claim 14, wherein the first agent and the second agent have at least one common constituent.

16. The method of claim 14, further comprising mixing a first constituent from a first fire suppression material source with a second constituent from a second fire suppression material source to form the first agent.

17. The method of claim 16, wherein the second agent comprises only the second constituent, and, wherein the first constituent is Pentafluoroethane (HFC-125) and the second constituent is Trifluoroiodomethane (CF₃I).

18. The method of claim 14, wherein at least one of the high rate discharge and the low rate discharge are performed automatically upon detection of the fire.

19. The method of claim 14, wherein the first agent comprises a mixture of hydrofluorocarbons, such as HFC-125, HFC-23, HFC-227ea, HFC-236fa, heptafluoroisopropyl pentafluoroethyl ketone, and/or Trifluoroiodomethane (CF₃I), in an azeotrope.

20. The method of claim 14, wherein the first agent contains solid particulate.
